(19) United States
(12) Patent Application Publication
(10) Pub. No.: US 2012/0104930 A1
(43) Pub. Date: May 3, 2012

(54) CORE-SHELL ELECTRON EMISSION MATERIAL

(75) Inventors: Zoltan Somogyvari, Budapest (HU); Laszlo Balazs, Budapest (HU); Csaba Horvath, Budapest (HU)

(73) Assignee: General Electric Company

(21) Appl. No.: 12/938,688

(22) Filed: Nov. 3, 2010

(51) Int. Cl. H01J 1/62; H01B 1/08; H01B 1/04; H01J 9/24

(52) U.S. Cl. 313/485; 445/26; 252/518.1; 252/520.2; 252/520.5; 252/521.3; 252/516

(57) ABSTRACT

The invention relates to an electron emission material for use in fluorescent lamps that releases a significantly reduced amount of decomposition material, predominantly CO₂, during in-lamp heat-treatment. Consequently, there is a significant reduction in the amount of electrode decomposition-related contaminants in the lamp. In addition, the emission material of the invention requires a much lower temperature in-lamp heat-treatment during manufacturing than that of conventional lamps of the same type. The invention, while described herein for use primarily with fluorescent lamps, has broader application to any device where the primary means of electron emission is of the thermionic type.

### BACKGROUND OF THE DISCLOSURE

The invention relates to an electron emission material for use in fluorescent lamps. More particularly, the invention provides an electron emission material that releases a significantly reduced amount of decomposition material, predominantly CO₂, during in-lamp heat-treatment. Consequently, there is a significant reduction in the amount of electrode decomposition-related contaminants in the lamp. In addition, the emission material of the invention requires a much lower temperature in-lamp heat-treatment during manufacturing than that of conventional lamps of the same type. The invention, while described herein for use primarily with fluorescent lamps, has broader application to any device where the primary means of electron emission is of the thermionic type.

Fluorescent lamps are known for use in a variety of applications and are available in a number of shapes and sizes. A fluorescent lamp or fluorescent tube is a gas-discharge lamp that utilizes electricity to excite mercury vapor. Typically, fluorescent lamps include a light-transmissive glass discharge chamber having disposed therein electrodes for providing an electric discharge to the interior of the chamber. Also enclosed in the discharge tube is a gaseous discharge fill, or dose, a source of mercury, and a phosphor material layer or source, generally disposed on the interior surface of the discharge chamber. In operation, power supplied to the electrodes from an exterior power source generate an electric arc between the tips of the two electrodes, causing the electrons in the discharge fill to excite mercury atoms in the mercury source that subsequently cause the phosphor layer to fluoresce, producing visible light.

Conventional fluorescent lamp electrodes require the use of high temperatures, up to and in some instances in excess of 1200° C., during the manufacturing process in order to decompose the electron source, generally initially disposed in the lamp in the carbonate form, to generate a more suitable oxide form of the source materials to operate the lamp and provide quality light emission over a sustained life. Oxide source materials provide superior thermionic electron emission properties as compared to that of, for example, the carbonate forms of the same source materials. The carbonate form is generally used, however, in initially dosing the lamp due to the highly unstable nature of the oxides in the presence of moisture and carbon dioxide present under ambient processing conditions. Therefore, in order to keep the emission material in a morphologically and compositionally stable form during storage, suspension making, and the electrode coil coating process, the electrode of the lamp is initially coated with source materials in the carbonate form. Once present, the carbonates must be decomposed to their oxide form, which requires the application of heat treatment temperatures of up to about 1200° C. in order to decompose the carbonates in a reasonable time period. CO₂ and other oxides generated as by-products of the decomposition process can be adsorbed by the inner phosphor coating of the discharge vessel, and react with metallic parts of the lamp heated up during decomposition to oxidize the same. While gaseous CO₂ is evacuated from the lamp, the metal oxides formed remain in the lamp as contaminants and degrade over-all lamp performance and shorten lamp life.

There have been attempts to design discharge lamps that avoid these drawbacks. For example, CO₂ and moisture insensitive materials such as Ba-tantalate, Ba-neodymate, Ba-tungstate, and Ca-tungstate have been investigated. However, none of these materials provide the low work function and long operating life of conventionally-used alkaline-earth triple oxides.

Based on the foregoing, there remains a need for a material, and a method of using such material, that overcomes the noted drawbacks while providing quality light and long lamp life.

### SUMMARY OF THE DISCLOSURE

The present invention, in at least one embodiment, meets these and other needs by providing an electron emission material exhibiting a core-shell grain morphology. The core of the core-shell grain is composed of the electron emission material, for example alkaline-earth oxides or mixed oxides, having disposed thereon an outer shell of protective material that prevents degradation of the oxide core due to reaction with moisture or CO₂ present during lamp manufacture.

In one embodiment there is provided a core-shell electron emission material comprising a core of alkaline earth oxide material, such as Ba-, Sr-, or Ca-containing oxide, coated with a material that is stable in ambient air.

In another embodiment the core-shell electron emission material includes an alkaline-earth oxide core having disposed thereon a shell material that does not contribute to mercury consumption during lamp operation.

In yet another embodiment the core shell electron emission material includes an alkaline-earth oxide core having disposed thereon a shell material that does not react with tungsten present in the lamp structure.

In still another embodiment the core shell electron emission material includes an alkaline-earth oxide core having disposed thereon a shell material that does not increase significantly the work function of the alkaline-earth oxide core.

In yet another embodiment there is provided a process for manufacturing a discharge lamp wherein the electron emission material is in the form of a core shell electron emission material including an alkaline-earth oxide core having disposed thereon a shell material, the method including the use of processing temperatures below 1000° C., for example down to about 500° C.

These and other embodiments, as presented herein, provide lamps that experience less performance degradation due to the presence in the discharge chamber of an electron emission material that does not require conversion from the carbonate to the oxide form of the alkaline-earth component, and as such avoids the generation of contaminants that reduce available mercury and otherwise degrade lamp performance. These and other advantages will be appreciated from an understanding of the teaching set forth in the embodiments disclosed herein.

### BRIEF DESCRIPTION OF THE DRAWINGS

FIG. 1 is a diagram of a discharge lamp in accord with an embodiment of the invention;

FIG. 2 is a graph illustrating reduced degradation of emission material due to the presence of a protective shell layer deposited by plasma synthesis on the emission material in accord with an embodiment of the invention;

FIG. 3 is a graph illustrating reduced degradation of emission material due to the presence of a protective shell layer deposited by solution deposition on the emission material in accord with an embodiment of the invention; and

FIG. 4 is a flow chart comparing conventional processing steps to processing steps according to an embodiment of the invention.

### DETAILED DESCRIPTION OF THE PREFERRED EMBODIMENTS

The invention relates to an electron emission material for use in fluorescent lamps. More particularly, the invention provides an electron emission material requiring much lower temperature in-lamp heat-treatment during manufacturing than conventional lamps of the same type, resulting in a significantly reduced emission of decomposition material, predominantly CO₂, during in-lamp treatment. Consequently, there is a significant reduction in the amount of electrode decomposition-related contaminants in the lamp. The invention, while described herein for use primarily with fluorescent lamps, has broader application to any device where the primary means of electron emission is of the thermionic type.

As used herein, the term “high temperature” refers to temperatures of about 1000° C. or higher at which conventional lamp carbonate materials are processed for conversion to oxide forms thereof.

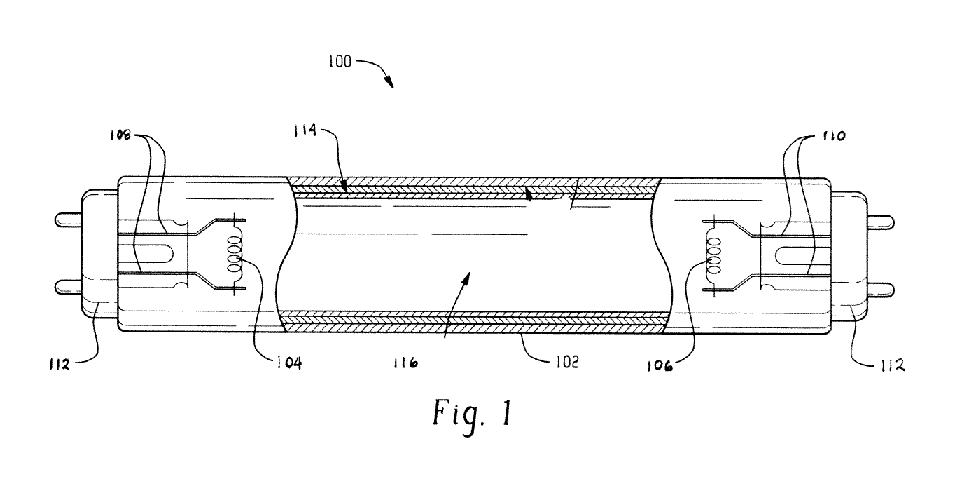

With reference to FIG. 1, there is provided a standard form fluorescent lamp 100. It is to be understood that while the lamp shown is in the configuration of a linear tube, this form is merely exemplary, and the invention disclosed herein finds application in any configuration of the lamp, including for example, curvilinear, U-shaped, compact, or any other known or used configuration. Lamp 100 includes a discharge chamber 102, having one or more phosphor layers or sources 114 disposed on the inner surface thereof, and a dose or fill 116 contained therein. The discharge tube further has disposed therein electrodes 104, 106 which are powered from an external source, not shown, through lead-in wires 108, 110. Electrodes 104, 106 are sealed hermetically into discharge chamber 102 by mount glass 112, which is heated during manufacture of the lamp to a temperature sufficient to create a vacuum-tight seal between the mount 112 and the discharge chamber 102.

In a conventional lamp, CO₂ generated during high temperature heat-treatment necessary to convert alkaline-earth carbonate electrode emission materials to alkaline-earth oxide electrode emission materials in a reasonable amount of time would have to be evacuated in order to avoid reduction in available mercury and the degradation of lamp performance. The contaminant CO₂ requires evacuation during and right after the decomposition step of manufacturing, but even with an evacuation process, some of the CO₂ generated will bind with the interior phosphor layer, which has a very high surface area, and be released during lamp operation under discharge conditions to react with and effectively remove available mercury. In addition, the high temperature used in such manufacturing processes, i.e. above about 1000° C., causes the metal components within the lamp to oxidize, resulting in the presence of metal oxide contaminants within the discharge chamber that release mercury consuming-oxygen, hampering lamp performance and reducing lamp life. However, because the current lamp employs a core-shell grain material comprising an electron emission material core already in the oxide form, the need for high temperature processing is avoided. Consequently, the generation of CO₂ as a result of such high temperature conversion process is also avoided, as well as the generation of metal oxide contaminants. As such, the lamp in accord with at least one embodiment of the invention exhibits enhanced light emission quality and lamp life.

As has been noted, conventional discharge lamps initially include one or more alkaline-earth carbonates. These materials, provided as the initial electron emission material, are necessary precursors to the alkaline-earth oxides that provide the work function and lamp life desired for fluorescent lamps. The materials are provided in the carbonate form and then converted to the oxide form under high temperature heat treatment to avoid premature degradation of the oxide material which is unstable in the presence of moisture and CO₂ present in the general atmosphere. During manufacture of a conventional lamp, at temperatures up to and in excess of 1000° C., the carbonates are converted to the oxide form of the alkaline-earth constituents. However, the conversion leaves behind CO₂ which reacts with and reduces the available mercury required for lamp operation. Therefore, excess mercury must be included to account for this initial reduction during normal high temperature processing. In addition, the high processing temperatures cause other metal components within the lamp to oxidize, thus generating contaminants that interfere with lamp operation by releasing oxygen which also contributes to unwanted mercury consumption, thus reducing light emission and shortening lamp life.

The current design, however, avoids all of the foregoing problems. In one aspect, because the core-shell electron emission material used includes an alkaline-earth oxide material core, as opposed to the conventional carbonate form of the alkaline earth component(s), there is no need to convert carbonate materials to oxides, thus allowing for a manufacturing process carried out at a much lower temperature. In addition to the benefits gained by using lower processing temperatures, given the lack of carbonates present in the electron emission material there is no generation of CO₂ that reacts with and reduces the available mercury in the lamp dose. Therefore, initial amounts of mercury can be reduced to that amount needed to operate the lamp for at least the rated lamp life, without including excess amounts thereto to account for loss due to reaction with CO₂ generated from a carbonate electron emission material during the use of high temperature heat-treatment and processing steps.

In another aspect, use of the core-shell electron emission material avoids the generation of metal oxide contaminants that result from high temperature heat treatments that cause metal lamp components to oxidize. Without the presence of these contaminants within the discharge chamber, the lamp operates more efficiently for a longer period of time, i.e. the lamp exhibits better quality light emission over a longer lamp life.

The core-shell electron emission material includes a core comprising at least one alkaline-earth oxide. Suitable alkaline earth oxides are chosen from, for example, Ba, Sr, and Ca, though other oxides may be used. The core is therefore similar to, if not the same as, the conversion oxide in a conventional high temperature processed lamp. In addition to the alkaline-earth oxide, one or more additives may be included in the core. Such additives include those that are generally applicable for addition to conventional electron emission materials. For example, it is known to add zirconium, in its metallic form or as an oxide (zirconia), to the core to increase the life of the electrode. Similarly, other known additives may be included without detracting from the premise of the invention.

The shell portion of the core-shell electron emission material is composed of a material that is stable in air. In addition, the material must be non-reactive with mercury, such that it does not reduce the available amount of mercury in the dose, and with tungsten, such that it does not detract from the electrode performance. Also, the material should not significantly increase the work function of the alkaline-earth oxide. Suitable shell materials include refractory oxides, carbides and nitrides. For example, the shell may be comprised of zirconia, yttria, silica, alumina, titania and silicon carbide.

The shell may be considered to be an active shell layer or a passive shell layer. The term “active shell layer” or “active shell” refers to a shell having an active role in lamp performance. As such, it is understood that this type of shell layer remains on the core at the completion of manufacture of the lamp. In one embodiment, the shell may gradually be removed over the operational life of the lamp as the temperature of the hot spot of the electrode increases. For example, a shell comprising ZrO₂ may be considered an active shell layer. ZrO₂ exhibits high resistance to ion sputtering which is present during normal operation of the lamp. Ion sputtering can be very destructive, particularly immediately following lamp ignition when the lamp is in the instant start mode, which refers to that mode where the electrode of the lamp is not pre-heated prior to ignition. Consequently, the ZrO₂, present on the initial electron emission material as an active layer, acts to decrease or slow the degradation of the electrode caused by ion sputtering. Alakaline-earth zirconates, which exhibit a higher resistance to ion sputtering than oxides, may also be used.

Another alternative to the foregoing takes into consideration that scenario wherein the shell is completely or partially diffused into the core material during operation, generating a homogenous electron emission material from the original core-shell structure. This may be accomplished, for example, by solid state diffusion of the core material through the shell, and generally may occur at the operational temperature of the electrode, which at its hottest portion, or the hot spot of the electrode, may be as high as 1200° C. over the life of the lamp. As the shell material is diffused into the core, zirconates are evolved on the surface of the particles. It is the evolved particles which then function to decrease degradation of the electrode due to ion sputtering.

The term “passive shell layer” or “passive shell” refers to a shell that is not intended to have an active role during the operational life of the lamp. As such, it is understood that this type of layer is substantially completely removed from the core material during lamp manufacture but after the gains have been disposed within the discharge chamber, so as to eliminate any possibility for exposure of the core material to air and/or moisture. Removal of the passive shell layer may be accomplished by exposing the same to a low temperature heat-treatment, such as by resistive heating of the electrode coil. Suitable passive shell layer materials include those set forth above.

By using the core-shell electron emission material in accord with at least one embodiment hereof, it is possible to significantly reduce the mercury dose of a discharge lamp. For example, in a conventional linear fluorescent lamp tube having a four foot length, subjected to high temperature heat-treatment during manufacture to convert alkaline-earth carbonate dose constituents to oxides, the required mercury dose, taking into consideration the loss of mercury to reaction with liberated CO₂, may be about 1 mg. In contrast, in the discharge lamp in accord with the invention, including a core-shell electron emission material and not requiring the application of a high temperature heat-treatment during manufacture, the mercury dose may be reduced to below 1 mg, i.e., to as low as about 0.3 mg, and even lower to about 0.1 mg. In use, therefore, the conventional carbonate electron emission mixture is replaced with the core-shell electron emission material disclosed herein, and all other lamp components and parameters may be held constant, with the exception that the amount of mercury required to generate quality light over the rated life of the lamp may be significantly reduced.

The core material is provided in the form of particles of the core composition. The shell may then be deposited onto the surface of the core particles by several methods including, but not limited to, chemical vapor deposition (CVD), atomic layer deposition (ALD), plasma synthesis, coating from sols of the shell material or deposition from solutions of the shell materials or their precursors.

### Example 1

### Process for Producing Core-Shell Structure Material by Plasma Synthesis

In this Example 1, the shell material, ZrO₂, was deposited on a standard Ca, Sr, and Ba carbonate emission mixture by plasma synthesis. A plasma flame was generated at atmospheric pressure by a Lepel radio frequency (RF) generator, at 3-5 MHz, connected to a TEKNA PL-35 torch at a maximum plate power of 30 kW. Argon was used as the plasma gas, at a flow rate of 20 l/min. The sheath gas was a mixture of Ar and O₂ with flow rates of 23 l/min and 20 l/min, respectively. Powders were injected axially into the hottest region of the plasma by a PRAXAIR powder feeder through a water-cooled probe.

An ethanol solution of zirconium precursor was delivered by a peristaltic pump at a constant rate of 8 ml/min⁻¹ to the atomizer nozzle, where it was dispersed by a 3 l/min⁻¹ flow of argon gas to form fine droplets of the precursor material. Samples of this material were collected from the wall of the reactor.

The foregoing process generated a ZrO₂ coating from zirconium propionate, available commercially from Aldrich as 70 mass % solution in propanol, Zr—PO, on a core comprised of a standard lamp mixture of co-precipitated calcium, strontrium, and barium carbonate, having a specific surface area of approximately 0.1 m²/g, calculated from the particle size distribution of the precursor material.

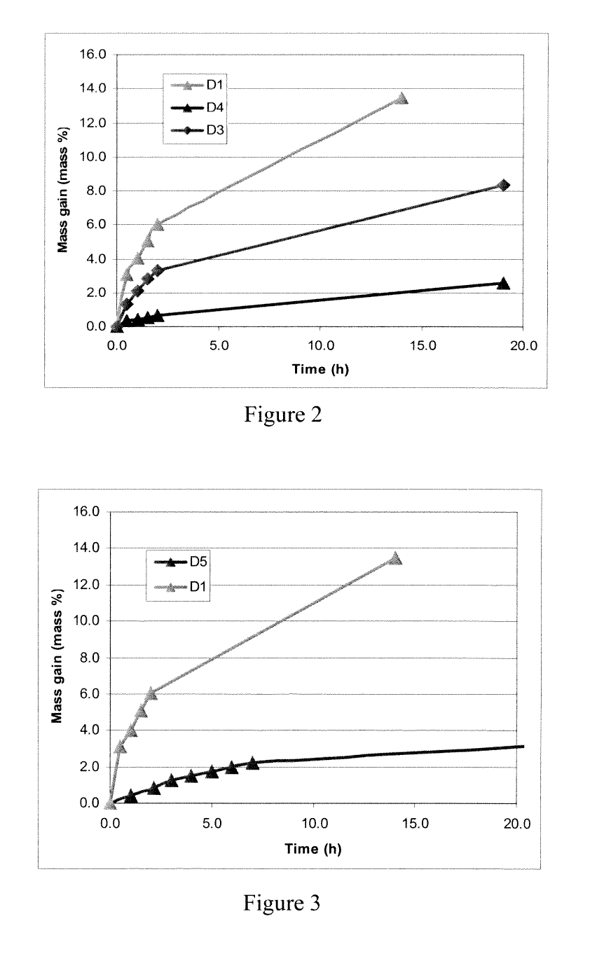

In order to establish the effectiveness of the coating, the materials prepared in accord with the foregoing, and collected from the wall of the reactor were analyzed with respect to reduction in the decomposition of the emission material. As has been previously stated, this decomposition results in the release of gases that react with the mercury dose causing a reduction in the amount of available mercury to support lamp operation. The test involved coating the core material, which was chosen to be consistent with currently used emission materials in known commercial lamp designs, i.e., the co-precipitated Ca, Sr, and Ba carbonate material noted above, with ZrO₂, in accord with the foregoing processing, at increasing concentrations. With reference to FIG. 2, there is provided a graph illustrating the rate of degradation of each sample tested under conditions of exposure to water and CO₂ in keeping with conditions that the coating would experience in a commercial lamp. In the Figure, Example D1 corresponds to uncoated electron emission material, i.e., commensurate with prior art emission materials. D2, the results of which are not included on the graph of FIG. 2, included a single monolayer of ZrO₂, which was found to impart no appreciable difference in the rate of emission material degradation. D3 corresponds to a substrate having a coating of 100 monolayers, and D4 included 2500 monolayers of the ZrO₂ shell material. The content of the core and shell materials was held constant in each sample tested, with only the coating concentration or thickness being increased.

FIG. 2 illustrates a decrease in degradation rate of the coating as the coating thickness increases, i.e., the presence of the coating reduces emissions that result in the decomposition of the electrode. In this FIG. 2, the sample denoted as D1, which is in accord with prior art lamps, having none of the current coating, shows a mass gain (mass %) at 14 hours time of about 13.5, while the D4 sample, having the thickest shell monolayer, shows an increase in mass of the emission material at 14 hours time upon exposure to ambient conditions, including the presence of water and CO₂ of only about 2. Sample D3, having a coating thickness of 100 monolayers, experienced an increase in mass at 14 hours time of only about 7. The gain in mass correlates to the generation of gases that would be released into the interior of the lamp chamber to react with available mercury and deplete the mercury dose, thus shortening lamp life and degrading light quality.

### Example 2

### Process for Producing Core-Shell Structure Material from Solution Deposition of the Shell Precursor Material

In this Example 2, the core or electron emission material was consistent with that used in Example 1 above. The co-precipitated Ca, Sr, and Ba carbonate, having a specific surface area of about 0.1 m²/g, was calcined at 1000° C. for 1 hour. Following calcining, the material was dispersed in ethanol and stirred for several hours. The resulting oxide suspension was mixed with zirconium propionate (available commercially from Aldrich as 70 mass % solution in propanol, Zr—PO). The precursor was then slowly precipitated with 96% ethanol. The precipitated material was heated at 500° C. for 1 hour. FIG. 3 sets forth a graph in keeping with that in FIG. 2, showing the percentage of mass increase of the material upon exposure to moisture and air, i.e., water and CO₂. As with FIG. 2, the sample denoted D1 corresponds to an emission material that does not include the ZrO₂ suspension, in accord with prior art lamps, and the sample denoted as D5 corresponds to a material prepared in accord with the foregoing solution processing to include ZrO₂. The graph in FIG. 3 shows the performance of the two samples over the first 20 hours of testing, though the samples were exposed to in lamp conditions for in excess of 200 hours. The D1 sample experienced an immediate and continued increase in mass, having reached a mass gain of about 13.5, in accord with the prior sample testing, after 14 hours time. In contrast, the D5 sample had experienced an increase in mass of only about 2.5 at this same time, representing a significant reduction. As with Example 1 above, the gain in mass correlates to the generation of gases that would be released into the interior of the lamp chamber to react with available mercury and deplete the mercury dose, thus shortening lamp life and degrading light quality. Therefore, the lamp in accord with an embodiment hereof experiences significantly reduced degrading gas generation during lamp manufacture and over time, thus enhancing light quality and lamp life.

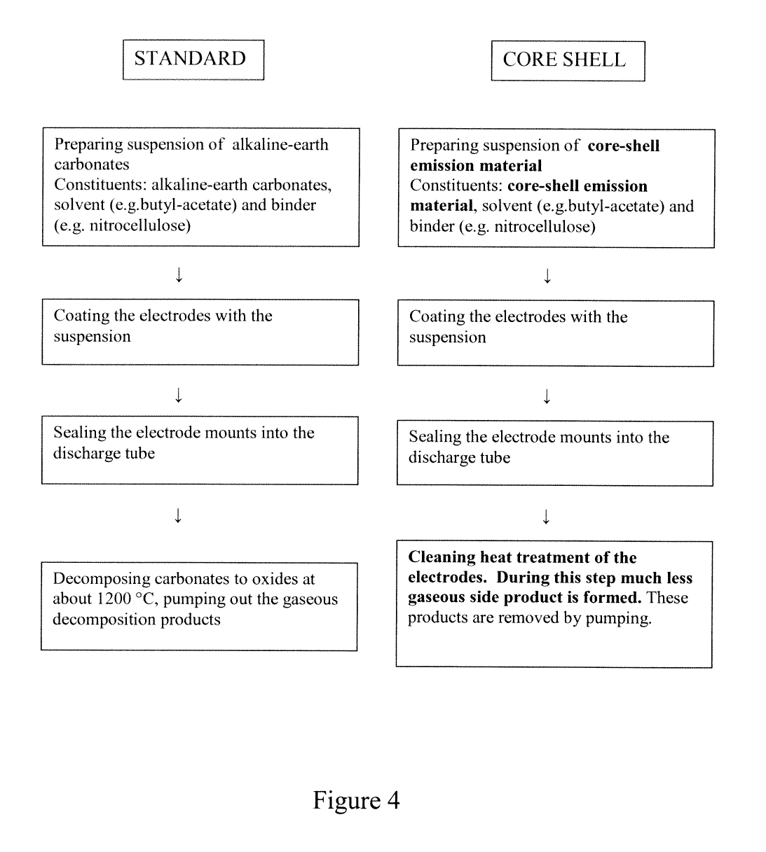

Lamps manufactured in accord with at least one embodiment hereof, as compared to lamps prepared in accord with standard lamp manufacturing processes, and including standard electron emission materials, do not require any special manufacturing parameters or equipment. A comparison of the processing used to manufacture both the standard and the inventive lamp disclosed and claimed herein is substantially the same, with the exception that in place of using the standard suspension of alkaline-earth carbonate materials, including alkaline-earth carbonates in a solvent, for example butyl acetate, and a binder, for example nitrocellulose, the current core shell emission material is used. This material may still be provided in a solvent, such as butyl acetate, and a binder, such as nitrocellulose. In both processes, the electron emission material suspension is coated or deposited onto the surface of the electrodes, the electrode mounts are sealed into the discharge tube or chamber. The standard method then employs a high temperature heat treatment, i.e. at about 1200° C., to decompose the carbonate emission materials to the oxide form needed to run the lamp, and the gases generated during this process must be pumped out of the discharge chamber, though a certain amount is left inside the chamber due to reaction thereof with other components within the chamber. In the manufacturing process used for the lamp in accord herewith, a much lower temperature heat treatment can be used to clean the electrodes. This low temperature heat treatment does not generate the same amount of gaseous byproduct, and more completely removes the same from the chamber by the same pumping mechanism used for standard lamp manufacture. However, because there was a significantly reduced amount of gaseous byproduct, there is a corresponding reduction in the amount of gas present to interfere with and degrade lamp performance. FIG. 4 provides a flow chart depicting the foregoing processes side-by-side to better illustrate the premise that little if any processing changes or alterations, beyond materials, is necessary to implement and gain the advantage achieved by using the deposition of the inventive coating disclosed herein.

The invention has been described with reference to certain embodiments. Obviously, modifications and alterations will occur to others upon reading and understanding the preceding detailed description. It is intended that the invention be construed as including all such modifications and alterations.

What is claimed is:

1. An electron emission material comprising an emission material exhibiting a core-shell grain morphology, wherein the core comprises an alkaline-earth oxide or mixed metal oxide and the shell comprises an air-stable material.

2. The electron emission material of claim 1 wherein the core comprises an alkaline earth oxide and the shell comprises a refractory oxide, carbide or nitride.

3. The electron emission material of claim 1 wherein the core comprises an alkaline earth oxide of at least one of barium, strontium, and calcium.

4. The electron emission material of claim 1 wherein the core further includes zirconium in its metallic or oxide form.

5. The electron emission material of claim 1 wherein the shell comprises at least one of zirconia, yttria, silica, alumina, titania, and silicon carbide.

6. The electron emission material of claim 1 wherein the core does not include a carbonate.

7. A discharge lamp comprising:
a discharge chamber;
at least one electrodes disposed in the discharge chamber and in electrical communication with an external power source;
a phosphor coating on an interior surface of the discharge chamber;
a mercury dose of less than 1.0 mg disposed in the discharge chamber; and
an electron emission material disposed on the at least one electrode, the electron emission material having a core-shell grain morphology and not including a carbonate material.

8. The discharge lamp of claim 7 wherein the core of the electron emission material comprises an alkaline-earth oxide or mixed metal oxide and the shell comprises an air-stable material.

9. The discharge lamp of claim 8 wherein the shell is non-reactive with at least one of mercury and tungsten.

10. The discharge lamp of claim 8 wherein the shell comprises an active shell layer selected from zirconia and an alkaline-earth zirconate.

11. The discharge lamp of claim 10 wherein the active shell layer remains on the core at the completion of lamp manufacture.

12. The discharge lamp of claim 10 wherein the active shell layer at least partially diffuses into the core during lamp operation.

13. The discharge lamp of claim 8 wherein the shell comprises a passive shell layer.

14. The discharge lamp of claim 7 wherein the mercury is present in an amount of less than 0.3 mg.

15. A method of manufacturing a discharge lamp, the method comprising:
a. providing a discharge vessel having an interior;
b. sealing at least one electrode within the discharge vessel;
c. providing a phosphor coating on the interior surface of the discharge vessel;
d. providing a mercury dose of less than 1.0 mg; and
e. providing an electron emission material having a core-shell grain morphology; and
f. heat-treating the discharge vessel including the electrodes, phosphor coating, mercury and electrode emission material at a temperature up to about 500° C. to fuse the electrodes into the discharge tube.

16. The method of claim 15 wherein the electron emission material has a core comprising at least one alkaline-earth oxide and a shell comprising a refractory oxide, carbide, or nitride.

17. The method of claim 15 wherein the electron emission material has a shell comprising at least one of zirconia, yttria, silica, alumina, titania, and silicon carbide.

18. The method of claim 15 wherein the electron emission material has a core comprising an alkaline earth oxide of at least one of barium, strontium, and calcium.

19. The method of claim 15 wherein step (e) further includes the steps of providing core particles of an alkaline-earth oxide and disposing a shell thereon by chemical vapor deposition, atomic layer deposition, plasma synthesis, coating from a sol, or solution deposition.

20. The method of claim 15 wherein the shell on the emission material is non-reactive with mercury and tungsten.
